(19) United States
(12) Patent Application Publication
(10) Pub. No.: US 2024/0385589 A1
(43) Pub. Date: Nov. 21, 2024

(54) CIRCULARITY ANALYSIS OF INDUSTRIAL PROCESSES

(71) Applicant: Accenture Global Solutions Limited, Dublin 4 (IE)

(72) Inventors: Ghanshyam DEVNANI, Bengaluru (IN); Siddharth Narain SINGH, Gurugram (IN); Nabuath Ulla KHAN, Mumbai (IN); Vivek LUTHRA, Hampton (AU); Aikansh JAIN, Delhi (IN); Monto Paul RODRIGUES, Mira Bhayandar (IN); Sven RUYTINX, Kuala Lumpur (MY); Auri Priyadharshini MUNIVELU, Bangalore (IN); Diganta NIL CHATTERJEE, Kolkata (IN); Vikrant PRAKASH, Sitamarhi (IN); Carlo FRUSINI, Bergamo (IT)

(73) Assignee: Accenture Global Solutions Limited, Dublin 4 (IE)

(21) Appl. No.: 18/319,685

(22) Filed: May 18, 2023

(51) Int. Cl. G05B 19/4155

(52) U.S. Cl. CPC G05B 19/4155; G05B 2219/31449

(57) ABSTRACT

A process circularity optimization system improves the circularity of industrial processes via a non-linear analysis of process attributes. A process input provides one or more target attributes to be optimized along with an objective function for improving the circularity of a manufacturing process. The input variables to be set to optimize the target attributes along with any constraints are accessed. Multiple input variable value combinations are generated via non-linear processing of the input variables and a combination of input variable values with the highest probability of success is implemented in the manufacturing process to optimize circularity.

### BACKGROUND

The need for sustainable and environmentally friendly practices in manufacturing and other industrial processes is becoming increasingly important in recent years. Sustainable manufacturing is based on the concept of circularity, which involves minimizing waste and maximizing the efficient use of resources. This can be achieved by designing processes to implement recycling, reuse, and remanufacturing as well as using renewable energy sources. However, achieving circularity in industrial processes can be challenging as it requires a comprehensive understanding of the entire value chain, from sourcing raw materials for production to disposal of used products. It also requires the development and implementation of new technologies that support sustainable practices.

### BRIEF DESCRIPTION OF DRAWINGS

Features of the present disclosure are illustrated by way of examples shown in the following figures. In the following figures, like numerals indicate like elements, in which:

FIG. 1 shows a block diagram of a process circularity optimization system in accordance with the examples disclosed herein.

FIG. 2 shows a block diagram of a process data collector in accordance with the examples disclosed herein.

FIG. 3 shows a diagram of a non-linear attribute processor in accordance with the examples disclosed herein.

FIG. 4 shows a block diagram of an output provider in accordance with the examples disclosed herein.

FIG. 5 shows a flowchart of a method of optimizing the circularity of a process in accordance with the examples disclosed herein.

FIG. 6 shows a flowchart of a method of obtaining the multiple combinations of the input variable values in accordance with the examples disclosed herein.

FIG. 7 shows a graphical user interface (GUI) that enables users to provide the process input requesting optimization of a process in accordance with the examples disclosed herein.

FIG. 8 illustrates a computer system that may be used to implement the process circularity optimization system in accordance with the examples disclosed herein.

### DETAILED DESCRIPTION

For simplicity and illustrative purposes, the present disclosure is described by referring to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

### 1. Overview

A process circularity optimization system that improves the circularity of an industrial process by providing recommendations and inputs to a manufacturing process to regulate a target attribute is disclosed. The system can be configured to receive data from the manufacturing process to identify input variables that affect the target attribute/variable. In an example, the data can include the logs of the various machines and processes within a manufacturing plant. A process input that identifies the target attribute that is to be optimized for circularity is provided to the system. Optimizations for circularity may increase or decrease the value of the target attribute by changing other input attributes or variables that affect the target attribute. The system can evaluate the values of the input variables and determine the changes to be made in the input variable values to achieve the requisite changes to the target attribute. Upon determining the changes to be made, the system may directly provide the input variable values to the manufacturing process via appropriate machine interfaces. Alternately, or additionally, recommendations may be transmitted as tasks to be executed or in messages to users configured within the system.

The process input provided to the system may not only identify the target attribute but may also identify any additional objectives to be achieved while optimizing the target attribute. The objectives may be provided as user-defined objective functions. The input variables are variables with a definite domain ranging between an upper possible value and the lower possible value and whose values are changed to achieve the desired results. The input variables may include certain independent key performance indicators (KPIs) and some dependent KPIs which are affected by other KPIs. Further, the system allows users to place constraints on the input variables in order to achieve the desired results.

The input variables along with the objectives and constraints (if any) are provided to a non-linear attribute optimizer which outputs many different combinations of input variable values that can be implemented in the manufacturing process to optimize the target attribute. This is because the input variable values can be obtained for each component or machine part involved in the manufacturing process and while the target attribute may vary linearly with one input variable for one component, the same target attribute may have a non-linear relationship with the same input variable for another component of the manufacturing process. Accordingly, a mathematical optimization model—Advanced Process OPTimizer (APOPT) solver model based on sequential quadratic programming and Branch and Bound method can be used to obtain the input variable values. In an example, the APOPT model can use the warm-start method to speed up non-linear programming optimization. The multiple combinations of input variable values generated by non-linear attribute optimizer need to be further filtered to identify the most suitable combination for implementation within the manufacturing process. A continuous probability distribution function (pdf) of success is calculated for each of the multiple combinations of input variable values. The pdfs of the multiple combinations of input variable values are compared and the combination of input variable values with the highest probability of success is selected for implementation in the manufacturing process.

The process circularity optimization system disclosed herein provides a technical solution of using a non-linear attribute optimizer to the technical problem of optimizing a target attribute (or target variable) which may be dependent on multiple input variables. Estimations for the target attribute may be obtained using a brute force algorithm in the absence of the optimization model by running the results of all possible combinations of input variable values for circular flow. Therefore, the input variable values are calculated for all possible combinations of circularity flow, and from the available list of combinations the calculated input variable values are matched with the desired results. This is a computationally intensive process that requires a significant amount of time to enlist all solutions. In one example, brute force calculation led to more than one million rows of output which consumed more than 8 hours of processing time to be generated.

Therefore, the process circularity optimization system includes a mathematical optimization model for measuring and optimizing the circularity of industrial processes which include manufacturing processes by recommending or providing required levels of input to achieve predefined targets on a real-time basis. The usage of the mathematical optimization model enabled achieving the targeted attribute values much faster by placing constraints on the resources and efficiencies. Furthermore, even when the mathematical model is configured to perform within the boundaries of predefined constraints, there remain chances that more than one input variable combination can result in the optimization of the target attribute. In such cases, the process circularity optimization system is configured to provide a user the option of choosing a solution or automatically selecting a combination of input variable values based on preset preferences e.g., lowest cost, maximum profit, lowest GHG emissions, etc. In generating the combination of input variable values, the residual impact on other input variables is also factored into the selection so that other input variables not referred to in the objectives or constraints bear the least impact.

Additionally, the multiple input variables on which the target attribute (or target variable) depends may be distributed across different entities of the industrial process. However, the relationships of the target attribute with a given input variable need not be uniform across the different entities. For example, as discussed above, the target attribute may vary linearly with an input variable when associated with one component of the manufacturing process while it may vary non-linearly with the input variable when associated with another component of the manufacturing process. Therefore, a non-linear mathematical model based on sequential quadratic programming which can accommodate both linear and non-linear optimization is used. The process circularity optimization system, therefore, enables an organization to not only estimate its current circularity with respect to various industrial processes but also to improve the circularity of the said processes with respect to different constraints.

### 2. System Architecture

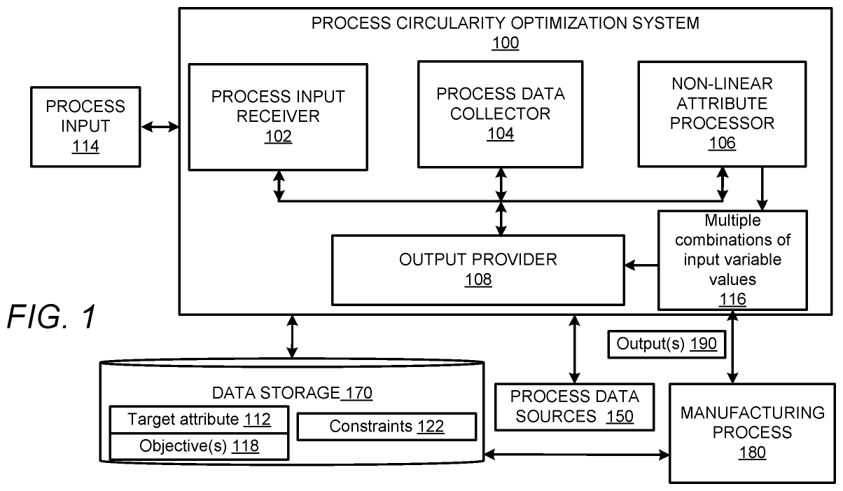

FIG. 1 shows a block diagram of a process circularity optimization system 100 in accordance with the examples disclosed herein. The system 100 can be configured to optimize or increase the circularity of a given process, e.g., a manufacturing process. In an example, the system 100 can access data regarding the process and produce output(s) 190 which when acted upon during the process, improve the circularity of the process. Particularly, in a manufacturing process 180, the outputs can include those which can be directly transmitted to the various equipment pieces involved in the manufacturing process to improve the circularity thereof. In an example, the outputs may also include recommendations/suggestions that can be provided to other entities involved in the manufacturing process to improve circularity. For example, the system 100 can output suggestions regarding the type of raw material to use in the manufacturing process, the methodology for waste disposal, the entities/parties involved in waste disposal, etc. In an example, the system 100 may also provide recommendations for socio-economic factors influencing and/or influenced by the manufacturing process for circularity optimization.

The system 100 can be communicatively coupled to process data source(s) 150 storing data regarding the manufacturing process. In an example, the process data sources 150 can store data regarding the various inputs for manufacturing processes, life cycle assessment data, etc., and the different outputs given out by the manufacturing process. The input data can include the various materials, quantities of materials, the different kinds of equipment pieces used in the manufacturing process, process attributes such as temperature, pressure, etc., at each of the equipment pieces, key performance indicators (KPIs), etc. In an example, the input data may also include not only the process attributes but also data regarding external factors such as the attributes of the environment at the geographic location where the manufacturing plant or facility is located, plastic waste value chain information, environmental impacts of waste management, life cycle impacts for postconsumer recycled resins, etc.

The system 100 includes a process input receiver 102, a process data collector 104, a non-linear attribute processor 106, and an output provider 108. The process input receiver 102 can receive inputs regarding the attributes of the manufacturing process 180 to be optimized either manually via a user entering the attribute data via a GUI with elements to receive the user inputs. In an example, the data from the manufacturing process 180 is received and stored, for example, in the data storage 170 which is communicatively coupled to the system 100, such data may be continuously or periodically analyzed by the system 100 so that if one or more of the attributes of the manufacturing process 180 fail predetermined criteria, it can start the system 100 to execute a corrective process of adjusting the input variables to ensure that the attributes remain within acceptable ranges.

The process input receiver 102 can analyze the process input 114 to determine a target attribute 112 of the manufacturing process to be optimized for circularity. The target attribute 112 can be dependent on other independent and/or dependent input variables (e.g., KPIs) so the circularity optimization of the target attribute 112 can be achieved by manipulating the other independent and/or dependent KPIs. In an example, the process input 114 can also include certain objectives 118 defined by a user so that the target attribute is optimized while maintaining the objective. Examples of objective functions can include:

$$Obj = min ( carrying cost ) ,$$

$$Obj = min ( total cost ) , or$$

$$Obj = max ( Profit ) .$$

The process data collector 104 can analyze the process input 114 (using, for example, textual processing techniques) to determine the target attribute 112 to be optimized for circularity and the associated manufacturing process 180. Further details regarding the target attribute 112 such as the independent and dependent input variables affecting the target attribute, and their ranges including the upper and lower possible values can also be obtained by the process data collector 104. As mentioned above, the data retrieved for optimizing the target attribute 112 can also include environment attributes. One or more of the input variables can have constraints associated therewith that limit the values that these variables can take. These constraints may be placed by users who know the domain or to limit the input variable values to optimize the target attribute 112. Some non-limiting examples of constraint equations for the constraints 122 are shown below:

$$Recycled material content \% >= 25 \% ;$$

$$Customer volume to\_formal / informal workers \% >= 90 \% ;$$

$$75 \% <= efficiency <= 90 \% ;$$

$$20 \% <= Incentive <= 30 \% ;$$

$$Formal to processing volume \% <= 20 \% ;$$

$$KPI [ p ] = Target\_KPI \_ [ p ] , where [ p ] is the party .$$

The data from the process data collector is provided to the non-linear attribute processor 106. The non-linear attribute processor 106 is based on non-linear mathematical methodologies as simplex models could not be used for some non-linear equations. The non-linear attribute processor 106 can analyze two types of inputs that can be provided as the process input 114—a process input with no objective functions specified and a process input wherein one or more objectives are specified. The non-linear attribute processor 106 upon analyzing the various input variables associated with the target attribute 112 along with the constraints (if any) may produce multiple combinations of input variable values 116 that can be maintained in order to improve the circularity of the manufacturing process.

The output provider 108 selects one of the multiple combinations of input variable values 116 to be implemented for optimizing the circularity of the target attribute. The implementation of the input variable value combination may depend on the entities associated therewith. In an example, if the input variables are attributes of the various machinery or equipment pieces of the manufacturing process 180, then the output provider 108 can be configured with the communication interface(s) so that the input variable values can be directly transmitted to such machinery. In an example, the implementation of the input variable value combination may involve social, or economic activities, then the output provider 108 may be configured to raise work items corresponding to such activities by sending notifications of recommendations or creating work items in to-do applications configured within the system 100.

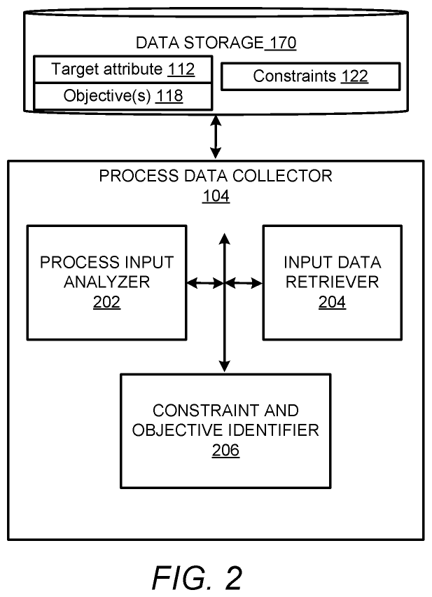

FIG. 2 shows a block diagram of the process data collector 104 in accordance with the examples disclosed herein. The process data collector 104 includes a process input analyzer 202, an input data retriever 204, and a constraint and objective identifier 206. When the process input 114 is received from a user via a GUI, the various elements such as the target attribute 112, the objective(s) 118, and any constraints 122 may be obtained from the inputs to the corresponding UI elements. If the process input 114 is instead received programmatically, the process input analyzer 202 can extract the information such as the target attribute, any specific objectives, particular constraints, etc., using, for example, text processing techniques. Upon determining the target attribute, the input data retriever 204 can be configured to retrieve the various input variables associated with the target attribute from the data regarding the manufacturing process 180 stored, for example, in the data storage 170. In an example, domain experts may identify, for each attribute of the manufacturing process, the independent and dependent variables that affect the attribute along with their current values and permissible values that the variables may take. The constraint and objective identifier 206 receives the objectives 118 from the process input 114 and the constraints 122 from one or more of the process input 114 and the process data source(s) 150.

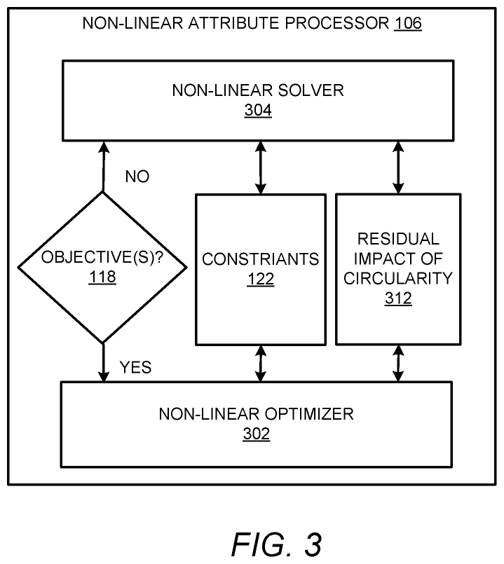

FIG. 3 shows a diagram of the non-linear attribute processor 106 in accordance with the examples disclosed herein. The non-linear attribute processor 106 can be based on Sequential Quadratic Programming. In an example, the non-linear attribute processor 106 implements the Branch and Bound method. The non-linear attribute processor 106 may include a non-linear solver 304 which determines the residual impact of the circularity 312 based on constraints 122 when no objective(s) 118 are imposed in the process input 114. When the process input includes objective(s) 118, then non-linear optimizer 302 may process the objective(s) 118 and provide the input variable values that comply with the constraints 122 while improving the circularity of the target attribute.

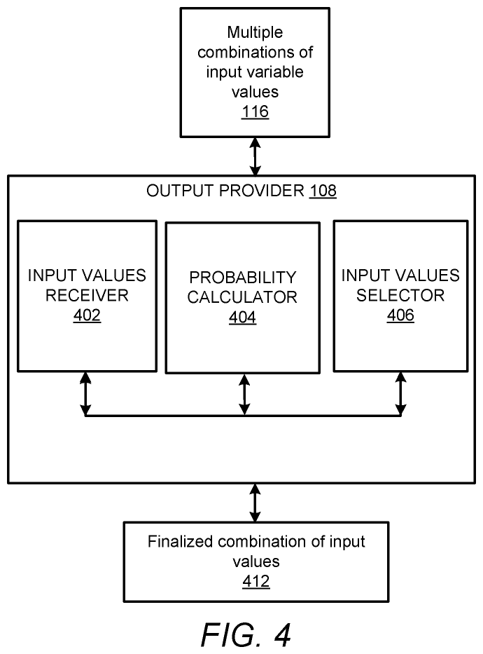

FIG. 4 shows a block diagram of the output provider 108 in accordance with the examples disclosed herein. The output provider 108 includes an input values receiver 402, probability calculator 404, and an input values selector 406. The input values receiver 402 receives the multiple combinations of the input variable values 116 produced by the non-linear attribute processor 106. The probability calculator 404 obtains the continuous probability distribution function (pdf) for each combination of the input variable values for determining the probability of succeeding in optimizing the circularity of the target attribute. The input values selector 406 selects a finalized combination of input values 412 with the highest probability for implementation by the manufacturing process 180.

### 3. Flowcharts

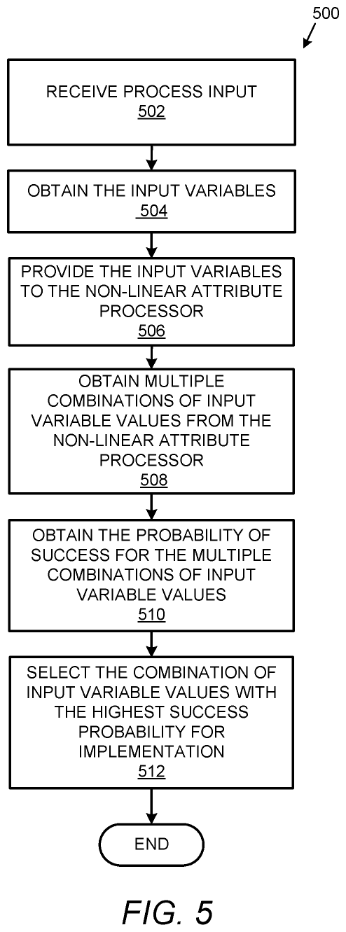

FIG. 5 shows a flowchart 500 of a method of optimizing the circularity of a process in accordance with the examples disclosed herein. Optimizing the circularity of a process e.g., a manufacturing process can include is optimized by setting values of one or more target attributes of the manufacturing process within corresponding predefined ranges. The circularity optimization may be discussed herein with respect to certain examples. It may be appreciated that these examples are provided by way of illustration and not limitation. The method begins at 502 wherein the process input 114 is received by the system 100, wherein the process input 114 indicates at least one target attribute of the manufacturing process 180 to be optimized for circularity. To optimize the target attribute for circularity, via setting a value of the target attribute within a corresponding predefined range. In an example, the target attribute may include greenhouse gas (GHG) emissions of a manufacturing process for polyethylene terephthalate (PET) bottles. In an example, the process input 114 may also include objectives that impose limits on setting a value for the target attribute. For example, an objective that less energy should be consumed in the manufacturing process may also be set.

At 504, the input variables to be employed for the circularity optimization of the target attribute are obtained. The input variables for setting the value for the GHG emissions may include data regarding the manufacturing process, life cycle assessment data, plastic waste value chain, environmental impacts of waste management, post-consumer recycled resins, etc. While some of the data is retrieved from the data storage 170, the process data stores 150 that store data regarding the manufacturing process 180, and some of the required data may also be retrieved from third-party sources e.g., websites, etc. The input variables thus obtained are provided to the non-linear attribute processor 106 at 506. In an example, the non-linear attribute processor 106 may be implemented using Advanced Process OPTimizer (APOPT), which is a software package for solving large-scale optimization problems for linear programming, non-linear programming, quadratic programming, etc.

The output obtained at 508 from the non-linear attribute processor 106 includes multiple combinations of the input variable values 116. In an example, the various input variable values 116 can be generated using brute force which would not only be expensive in terms of processing resources but would also be inefficient in terms of time. By providing the target attribute and the input variables to the APOPT model, the process of identifying the multiple combinations of the input variable values 116 is not only speeded up but is also made less expensive in terms of processing resources. Referring to the example to reduce GHG emissions with the objective of lesser energy consumption, a combination of input variables can be produced wherein one of the input variables can be the amount of recycled material used in the manufacturing process and the water consumed in the manufacturing process. The input variable values provided by the non-linear attribute processor 106 can recommend increasing the usage of recycled PET resin as opposed to using virgin PET resin in the manufacture of PET bottles to reduce GHG emissions. Another input variable value that pertains to the usage of water may indicate marginally higher water consumption on reducing the virgin material. Yet another input variable value pertaining to the environment attribute may indicate that the increased usage of recycled material increases the recovery of used bottles resulting in lesser waste to the landfill and in turn reducing the GHG emission (methane emitted from the landfill dump). At 510, the probability of success is obtained for each such combination of the multiple combinations of the input variable values 116. The probability of success of the input variable value combinations can be based on past data and a continuous probability distribution function can be indicative of the feasibility of achieving the circularity flows. The combination of input variable values with the highest probability of success is selected at 512 to be implemented for optimizing the circularity of the manufacturing process by setting the value of the target attribute within the corresponding predefined range.

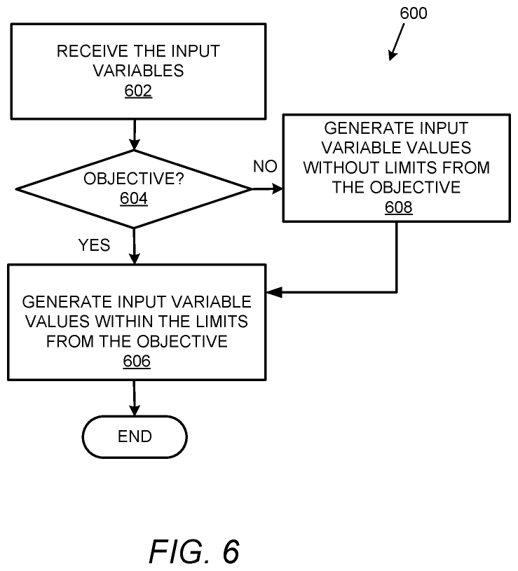

FIG. 6 shows a flowchart 600 of a method of obtaining the multiple combinations of the input variable values 116 in accordance with the examples disclosed herein. The method begins at 602 the input variables associated with the target attribute to be optimized are received. At 604, it is determined if one or more objectives were specified in process input 114. If an objective is specified in the process input 114, then the input variable values to be implemented for optimizing the target attribute are generated at 606 subject to the limitations imposed by the objective(s). If an objective is not specified, the input variable values are determined at 608 without limits from the objective(s). Accordingly, more combinations of values for the input variables are generated at 606 than at 608. In either case, the non-linear attribute processor 106 can be implemented by the APOPT methodology to produce the multiple combinations of input variable values 116. It may be appreciated that the various input variable values can be generated entity-wise or component-wise so that the characteristics such as resource usage, waste generated, etc. can be studied for each component of the manufacturing process 180. Therefore, the same input variable or KPI may be linear for one component whereas it is non-linear for another component and APOPT methodology is suitable for processing both types of variables.

### 4. User Interface

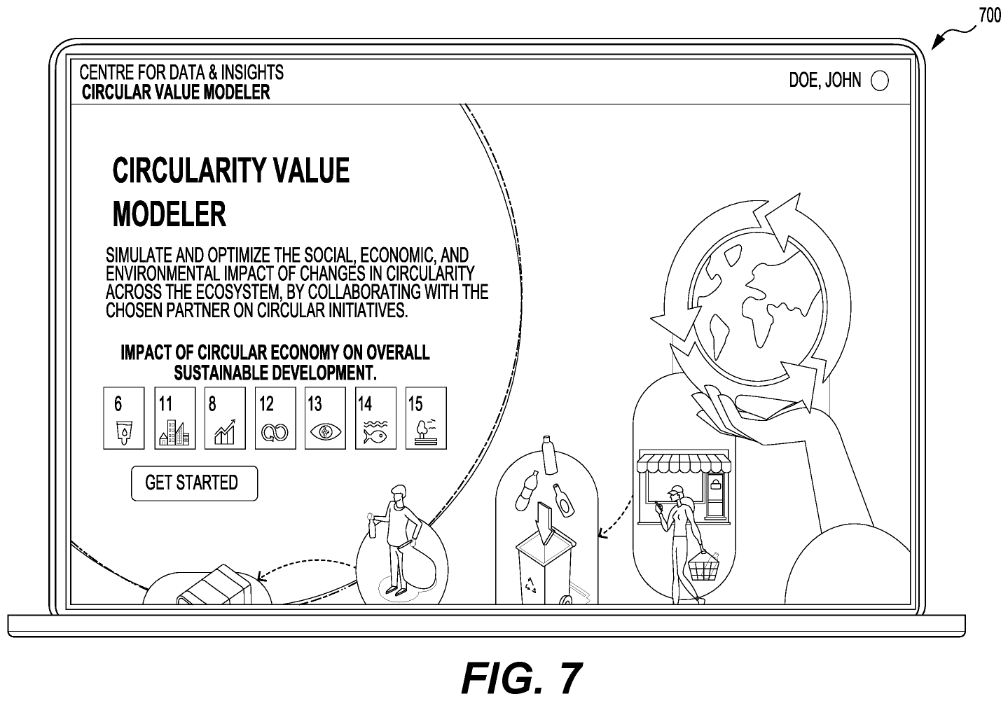

FIG. 7 shows a GUI 700 that enables users to provide the process input 114 requesting optimization of the target attribute in accordance with the examples disclosed herein. The GUI 700 can be put forth by the process input receiver 102 for collecting initial data such as the target attribute 112 to be optimized, and constraints 122 if any to be imposed on the input variables used in the optimization process and specific objectives to be achieved under the optimization process. The generation of input variable values may not only drive manufacturing processes but may also generate recommendations for the economic and social upliftment of communities in which such manufacturing facilities may be located.

### 5. System Diagram

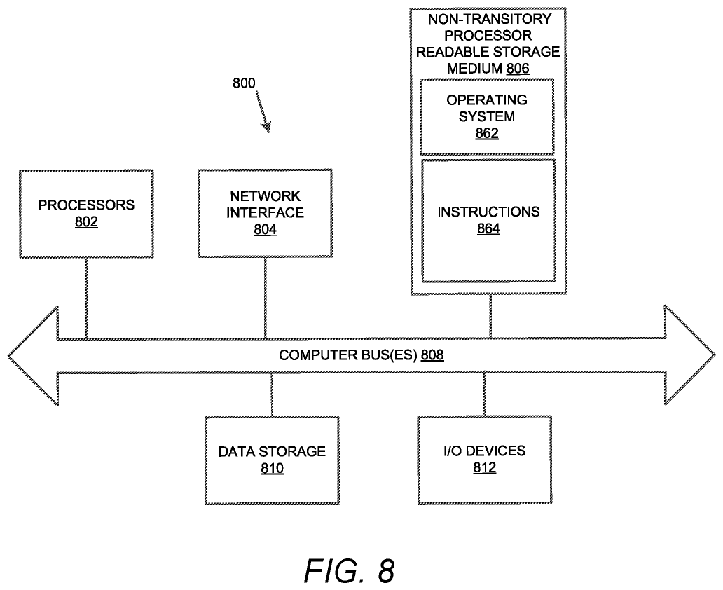

FIG. 8 illustrates a computer system 800 that may be used to implement the process circularity optimization system 100 in accordance with the examples disclosed herein. More particularly, computing machines such as desktops, laptops, smartphones, tablets, and wearables which may be used to generate or access the data from the process circularity optimization system 100 may have the structure of the computer system 800. The computer system 800 may include additional components not shown and some of the process components described may be removed and/or modified. In another example, a computer system 800 can sit on external-cloud platforms such as Amazon Web Services, AZURE® cloud or internal corporate cloud computing clusters, or organizational computing resources, etc.

The computer system 800 includes processor(s) 802, such as a central processing unit, ASIC or another type of processing circuit, input/output (I/O) devices 812, such as a display, mouse keyboard, etc., a network interface 804, such as a Local Area Network (LAN), a wireless 802.11x LAN, a 3G, 4G or 5G mobile WAN or a WiMax WAN, and a processor-readable medium 806. Each of these components may be operatively coupled to a bus 808. The processor-readable or computer-readable medium 806 may be any suitable medium that participates in providing instructions to the processor(s) 802 for execution. For example, the processor-readable medium 806 may be a non-transitory or non-volatile medium, such as a magnetic disk or solid-state non-volatile memory, or a volatile medium such as RAM.

The instructions or modules stored on the processor-readable medium 806 may include machine-readable instructions 864 executed by the processor(s) 802 that cause the processor(s) 802 to perform the methods and functions of the process circularity optimization system 100.

The process circularity optimization system 100 may be implemented as software or machine-readable instructions stored on a non-transitory processor-readable storage medium and executed by one or more processors 802. For example, the computer-readable storage medium or non-transitory processor-readable medium 806 may store an operating system 862, such as MAC OS, MS WINDOWS, UNIX, or LINUX, and code/instructions 864 for the process circularity optimization system 100. The operating system 862 may be multi-user, multiprocessing, multitasking, multithreading, real-time, and the like. For example, during runtime, the operating system 862 is running and the code for the Process circularity optimization system 100 is executed by the processor(s) 802.

The computer system 800 may include a data storage 810, which may include non-volatile data storage. The data storage 810 stores any data used by the process circularity optimization system 100. The data storage 810 may be used as local data storage of the process circularity optimization system 100 to store the process input 114, the target attribute, the multiple combinations of input variable values 116, etc.

The network interface 804 connects the computer system 800 to internal systems for example, via a LAN. Also, the network interface 804 may connect the computer system 800 to the Internet. For example, the computer system 800 may connect to web browsers and other external applications and systems via the network interface 804.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

What is claimed is:

1. A process circularity optimization system, comprising:
at least one processor;
a non-transitory, processor-readable medium storing machine-readable instructions that cause the at least one processor to:
receive a process input indicating at least one target attribute of a manufacturing process to be optimized for circularity,
wherein the at least one target attribute is optimized via setting a value of the target attribute within a corresponding predefined range;
obtain input variables to be employed for the circularity optimization of the at least one target attribute,
wherein the input variables include key performance indicators (KPIs) of the manufacturing process and at least one environment attribute of a location of the manufacturing process;
provide the input variables to a non-linear attribute optimizer;
obtain from the non-linear attribute optimizer, multiple combinations of input variable values that are to be maintained for the input variables in the manufacturing process for obtaining a value of the at least one target attribute within the corresponding predefined range;
select one of the multiple combinations of input variable values; and
transmit the selected combination of the input variable values to equipment engaged in the manufacturing process.

2. The process circularity optimization system of claim 1, wherein to select one of the multiple combinations of input variable values, the non-transitory, processor-readable medium stores further machine-readable instructions that cause the at least one processor to:
obtain a probability of success for each of the combinations of input variable values obtained from the non-linear attribute optimizer.

3. The process circularity optimization system of claim 2, wherein the at least one processor is to further:
select one of the combinations of input variable values with a highest probability of success to be provided to the equipment for the circularity optimization of the manufacturing process.

4. The process circularity optimization system of claim 1, wherein each of the input variable values is associated with a definite domain with the input variable value lying between an upper possible value and a lower possible value.

5. The process circularity optimization system of claim 4, wherein a user input further includes constraints on one or more of the input variables.

6. The process circularity optimization system of claim 5, wherein to select one of the multiple combinations of input variable values when the constraints are identified, the non-transitory, processor-readable medium stores further machine-readable instructions that cause the at least one processor to:
select, by the non-linear attribute optimizer, one of the multiple combinations of input variable values wherein the input variable values of the one or more input variables lie between the upper possible values and the lower possible values that satisfy the constraints.

7. The process circularity optimization system of claim 6, wherein to select one of the multiple combinations of input variable values when the constraints are identified, the non-transitory, processor-readable medium stores further machine-readable instructions that cause the at least one processor to:
provide a constraint equation for each of the constraints to the non-linear attribute optimizer.

8. The process circularity optimization system of claim 1, wherein the target attribute is associated with different entities.

9. The process circularity optimization system of claim 8, wherein to optimize circularity of the at least one target attribute the non-transitory, processor-readable medium stores further machine-readable instructions that cause the at least one processor to:
obtain from the non-linear attribute optimizer, multiple combinations of the input variable values identified for each of the different entities.

10. The process circularity optimization system of claim 1, wherein the non-linear attribute optimizer includes an Advanced Process OPTimizer (APOPT) solver model based on sequential quadratic programming and branch and bound method.

11. The process circularity optimization system of claim 10, wherein the APOPT solver model uses warm-start to speed up outputting the combinations of input values of the input variables.

12. A method of optimizing circularity of a manufacturing process comprising:
receiving a process input indicating at least one target attribute of the manufacturing process to be optimized for circularity,
wherein the at least one target attribute is optimized by setting a value of the target attribute within a corresponding predefined range;
obtaining input variables to be employed for the circularity optimization of the at least one target attribute,
wherein the input variables include key performance indicators (KPIs) of the manufacturing process and at least one environment attribute of a location of the manufacturing process;
processing the input variables via sequential quadratic programming with branch and bound method;
obtaining from the processing of the input variables, multiple combinations of input variable values that are to be maintained for the input variables in the manufacturing process for obtaining a value of the at least one target attribute within the corresponding predefined range;
selecting one of the multiple combinations of input variable values; and
transmitting the selected combination of the input variable values to equipment engaged in the manufacturing process.

13. The method of optimizing the circularity of claim 12, wherein selecting one of the multiple combinations of the input variables further includes:
obtaining a probability of success for each of the combinations of input variable values; and
selecting one of the combinations of input variable values with a highest probability of success to be provided to the equipment for the circularity optimization of the manufacturing process.

14. The method of optimizing the circularity of claim 13, wherein the manufacturing process pertains to manufacture of polyethylene terephthalate (PET) bottles and an objective function includes minimizing greenhouse gas (GHG) emissions.

15. The method of optimizing the circularity of claim 14, wherein the target attribute includes usage of recycled resins in the manufacture of PET bottles.

16. The method of optimizing the circularity of claim 15, wherein processing the input variables includes:
processing data from the manufacturing process, plastic waste value chain, waste management, and post-consumer recycling processes.

17. A non-transitory processor-readable storage medium comprising machine-readable instructions that cause a processor to:
receive a process input indicating at least one target attribute of a manufacturing process to be optimized for circularity,
wherein the at least one target attribute is optimized via setting a value of the target attribute within a corresponding predefined range;
obtain input variables to be employed for the circularity optimization of the at least one target attribute,
wherein the input variables include key performance indicators (KPIs) of the manufacturing process and at least one environment attribute of a location of the manufacturing process;
provide the input variables to a non-linear attribute optimizer;
obtain from the non-linear attribute optimizer, multiple combinations of input variable values that are to be maintained for the input variables in the manufacturing process for obtaining a value of the at least one target attribute within the corresponding predefined range;
select one of the multiple combinations of input variable values; and
transmit the selected combination of the input variable values to equipment engaged in the manufacturing process.

18. The non-transitory processor-readable storage medium of claim 17, including further instructions that cause the processor to:
obtain a probability of success for each of the combinations of input variable values; and
select one of the combinations of input variable values with a highest probability of success to be provided to the equipment for the circularity optimization of the manufacturing process.

19. The non-transitory processor-readable storage medium of claim 17, wherein to obtain the multiple combinations of input variable values from the non-linear attribute optimizer, the processor is to:
implement sequential quadratic programming with branch and bound method by the non-linear attribute optimizer.

20. The non-transitory processor-readable storage medium of claim 19, including further instructions that cause the processor to:
implement warm start for the non-linear attribute optimizer.
